(19) United States
(12) Patent Application Publication
(10) Pub. No.: US 2022/0365853 A1
(43) Pub. Date: Nov. 17, 2022

(54) FAULT DETECTION IN NEURAL NETWORKS

(71) Applicant: Arm Limited, Cambridge (GB)

(72) Inventors: Andrew Brian Thomas HOPKINS, Cambridge (GB); Graeme Leslie INGRAM, Cambridge (GB); Elliot Maurice Simon ROSEMARINE, Cambridge (GB); Antonio PRIORE, Cambridge (GB)

(21) Appl. No.: 17/807,054

(22) Filed: Jun. 15, 2022

Related U.S. Application Data
(63) Continuation of application No. PCT/GB2020/053331, filed on Dec. 21, 2020.

(30) Foreign Application Priority Data
Dec. 19, 2019 (GB) 1918880.4

(51) Int. Cl. G06F 11/14; G06N 3/04; G06N 3/08; G06N 3/063; G06F 9/48

(52) U.S. Cl. CPC G06F 11/1476; G06N 3/04; G06N 3/08; G06N 3/063; G06F 9/4881; G06F 2201/805

(57) ABSTRACT

A method of performing fault detection during computations relating to a neural network comprising a first neural network layer and a second neural network layer in a data processing system, the method comprising: scheduling computations onto data processing resources for the execution of the first neural network layer and the second neural network layer, wherein the scheduling includes: for a given one of the first neural network layer and the second neural network layer, scheduling a respective given one of a first computation and a second computation as a non-duplicated computation, in which the given computation is at least initially scheduled to be performed only once during the execution of the given neural network layer; and for the other of the first and second neural network layers, scheduling the respective other of the first and second computations as a duplicated computation.

### CROSS-REFERENCE TO RELATED APPLICATIONS

This application is the U.S. national stage application filed pursuant to 35 U.S.C. 365(c) and 120 as a continuation of International Patent Application No. PCT/GB2020/053331, filed Dec. 21, 2020, which application claims priority to United Kingdom Patent Application No. 1918880.4, filed Dec. 19, 2019, which applications are incorporated herein by reference in their entireties.

### TECHNICAL FIELD

The present invention relates to methods, apparatus and systems for performing fault detection during neural network processing.

### BACKGROUND

Neural network computations may be performed in data processing systems including microprocessors such as neural processing units (NPUs), central processing units (CPUs), and graphics processing units (GPUs).

An NPU is an example of a data processing system which includes parallel computing components. An NPU is a type of microprocessor that specialises in the acceleration of machine learning algorithms. It is also known as a neural processor. An NPU may be included in microchips in various host devices such as mobile telephones, cameras and autonomous vehicles, alongside other types of microprocessor such as CPUs and GPUs. Neural network processing can be performed in a CPU, a GPU and/or an NPU, alone or in combination.

Fault detection to detect hardware faults during neural network processing can be computationally intensive, particularly in applications that comprise safety critical systems. It is therefore desirable to improve the computational efficiency of fault detection, whilst meeting operational requirements such as safety standards.

### SUMMARY

According to a first aspect of the present disclosure, there is provided a method of performing fault detection during computations relating to a neural network comprising a first neural network layer and a second neural network layer in a data processing system, the method comprising:

scheduling computations onto data processing resources for the execution of the first neural network layer and the second neural network layer, wherein the scheduling includes:

for a given one of the first neural network layer and the second neural network layer, scheduling a respective given one of a first computation and a second computation as a non-duplicated computation, in which the given computation is at least initially scheduled to be performed only once during the execution of the given neural network layer; and

for the other of the first and second neural network layers, scheduling the respective other of the first and second computations as a duplicated computation, in which the other computation is at least initially scheduled to be performed at least twice during the execution of the other neural network layer to provide a plurality of outputs;

performing computations in the data processing resources in accordance with the scheduling; and

comparing the outputs from the duplicated computation to selectively provide a fault detection operation during processing of the other neural network layer.

According to a second aspect of the present disclosure, there is provided a data processing system configured to perform fault detection during computations, the data processing system comprising:

control circuitry; and

one or more computing components configured to provide data processing resources,

wherein the control circuitry is configured to schedule computations onto the plurality of data processing resources for the execution of a first neural network layer and a second neural network layer, including:

for a given one of the first neural network layer and the second neural network layer, scheduling a respective given one of a first computation and a second computation as a non-duplicated computation, in which the given computation is at least initially scheduled to be performed only once during the execution of the given neural network layer; and

for the other of the first and second neural network layers, scheduling the respective other of the first and second computations as a duplicated computation, in which the other computation is at least initially scheduled to be performed at least twice during the execution of the other neural network layer to provide a plurality of outputs,

wherein the data processing system is configured to compare the outputs from the duplicated computation to selectively provide a fault detection operation during processing of the other neural network layer.

According to a third aspect of the present disclosure, there is provided a method of generating a hardware configuration addressing an operational performance target for a data processing system that is programmable to execute a first neural network layer and a second neural network layer, the method comprising:

determining a first operation for one of the first neural network layer and second neural network layer;

determining a first fault detection operation for the other of the first neural network layer and the second neural network layer, wherein the first operation and the first fault detection operations may differ from one another and wherein a combination of the first operation and the first fault detection operation can address the operational performance target for the neural network; and

determining a hardware configuration for the data processing system, wherein the hardware configuration is operable to provide the first operation and the first fault detection operation.

According to a fourth aspect of the present disclosure, there is provided a non-transitory computer-readable storage medium comprising computer-executable instructions stored thereon which, when executed by at least one processor, cause the at least one processor to generate a hardware configuration addressing an operational performance target for a data processing system that is programmable to execute a first neural network layer and a second neural network layer, the instructions comprising the steps of:

determining a first operation for one of the first neural network layer and second neural network layer;

determining a first fault detection operation for the other of the first neural network layer and the second neural network layer, wherein the first operation and the first fault detection operations may differ from one another and wherein a combination of the first operation and the first fault detection operation can address the operational performance target for the neural network; and

determining a hardware configuration for the data processing system, wherein the hardware configuration is operable to provide the first operation and the first fault detection operation.

Further features of the present disclosure will become apparent from the following description of embodiments, given by way of example only, which is made with reference to the accompanying drawings.

### BRIEF DESCRIPTION OF THE DRAWINGS

FIG. 1 shows a simplified representation of a convolutional neural network.

FIG. 2 shows a method for providing fault detection for a neural network.

FIG. 3 shows a method of performing fault detection during computations in a neural network.

FIG. 4 shows an alternative method of performing fault detection during computations in a neural network.

FIG. 5 is a schematic block diagram showing an example of a data processing system.

FIG. 6 is a schematic block diagram showing a computation engine of the data processing system of FIG. 5.

### DETAILED DESCRIPTION

Details of systems and methods according to examples will become apparent from the following description, with reference to the Figures. In this description for the purpose of explanation, numerous specific details of certain examples are set forth. Reference in the specification to ‘an example’ or similar language means that a particular feature, structure, or characteristics described in connection with the examples is included in at least that one example, but not necessarily in other examples. It should further be noted that certain examples are described schematically with certain features omitted and/or necessarily simplified for ease of explanation and understanding of the concepts underlying the examples.

Functional safety is a consideration for many systems, products and processes, across a broad range of sectors and applications. An aspect of functional safety is the detection of so-called ‘random’ hardware faults. Random hardware faults can be permanent, for example breakages of wires or short circuits, or transient, for example as a result of interference from charged particles, electromagnetic waves, external noise, intermittent connectivity and so on. In general terms, the greater the functional safety requirements for a system, the more robust the fault detection must be for that system.

In a microprocessor, microchip or similar circuit, permanent hardware faults can be detected by continuous checking operations, such as by complete duplication of hardware, or through the use of error detection/correction codes (ECCs). Permanent faults can also be detected by periodic checking using test patterns or check models, which can be implemented as hardware mechanisms or as software running on a microcontroller or other processor. Periodic checks within a fault-tolerant time interval are generally considered to be effective at detecting permanent faults but not necessarily at detecting transient faults.

Examples of periodic hardware checking for logic circuits include Logic Built-In-Self-Test (LBIST) and directed scan testing, both of which exploit the scan-chain based infrastructure that is typically used for functional testing of a microprocessor, microchip or similar circuit. Software testing is often performed using a so-called Software Test Library (STL), which performs functional testing of logic, as an alternative to scan-chain techniques. Other hardware test schemes are also possible. For example, hardware may generate test patterns and check the result aligns with expectation. Also, the hardware may contain hardware that can be used to check the result by for example generating a parity bit using a separate computation and checking the results.

Microchip or microprocessor storage (or ‘memory’) can usually be tested using a Memory Built-In-Self-Test (MBIST) controller, which uses a sequence of read or write accesses. MBIST detects permanent faults. Additionally, microchip/microprocessor storage is usually equipped with ECCs, to detect and potentially to correct permanent or transient faults in the memory bit cells. MBIST and ECCs can be applied for memories, alongside periodic or continuous checking of logic. MBIST can be performed by an MBIST controller when the system (in which the microchip or microprocessor is incorporated) is offline or by an online MBIST controller that tests the memory while the system is operational.

Continuous testing through full duplication of hardware can address both permanent and transient faults. Classically, this approach is therefore often employed for systems that are classified as being ‘safety-critical.’ However, providing full duplication of hardware and comparison circuitry generally more than doubles the cost of implementing a capability in a microprocessor, microchip or similar circuit. It can also limit the computational capacity within a microprocessor, microchip or similar circuit, to perform other functions. Particularly in systems that require a large amount of neural processing, providing full duplication of hardware may not be regarded as an attractive option. However, such systems may nonetheless have to meet safety standards, which can be very high for safety-critical systems.

The fault detection capability of a microprocessor, microchip or similar circuit is quantifiable by a Single Point Fault Metric (SPFM) and by a Latent Fault Metric. SPFM is defined as the ratio between the number of a device or system's detectable and safe single point hardware failures, and its total number of failures. Therefore, in essence, SPFM is a metric that can be used to quantify the fault detection capabilities of a device or system. As a general principle, a higher SPFM indicates a safer device or system. If a device or system is classified as being ‘safety-critical’, the SPFM target for that device or system is likely to be high, as compared to the SPFM targets for other devices or systems, for which the safety demands are less stringent.

An indicator of residual failure rate for a microprocessor or microchip or similar circuit is its Probabilistic Measure of Hardware Failure (PMHF). PMHF depends on many factors such as the physical properties of the device and its fault detection capabilities, as quantified by the SPFM. As a general principle, a lower PMHF indicates a safer device or system. If the PMHF is very low, it may be permissible for the device or system to have a lower SPFM than is usually required, and still meet certain safety criteria. Conversely, if the PMHF for a device or system is high, making changes that increase the SPFM will generally lower, and therefore improve, the PMHF.

Some examples described below relate to providing fault detection capabilities for neural networks, and for devices and systems comprising one or more processing units designed to run such neural networks. A neural network may be broken down into layers and each layer into several, often many, very similar sub-tasks that can be processed independently in the form of calculations or processes are carried out simultaneously (in parallel), and/or in sequence, in a plurality of parallel computing components and of which the results are combined upon completion of the sub-tasks.

A neural processing unit (NPU), or neural processor, can accelerate machine learning algorithms, by operating on and efficiently processing predictive models such as artificial neural networks. There are various types of neural network, such as convolutional neural networks (CNNs) and recurrent neural network (RNNs) and similar. CNNs are often employed for object detection, for example in image processing.

Neural networks such as CNNs may comprise various layer types such as: convolution layer(s), pooling layer(s), activation layer(s) and fully connected layer(s). Layers may be fused (combined) and treated as a fused layer. Other layer types are also well known, and various subcategories exist. In general terms, a specific neural network is defined by its particular arrangement and combination of layer types. However, modification of specific neural networks is typical, and training of a neural network (discussed below) can determine how it responds to input data.

A neural network typically includes several interconnected nodes, which may be referred to as artificial neurons, or neurons. The internal state of a neuron (sometimes referred to as an ‘activation’ of the neuron) typically depends on one or more inputs received by the neuron. The output of the neuron may then depend on the input, a weight, a bias and an activation function. The output of some neurons is connected to the input of other neurons forming a directed, weighted graph in which vertices (corresponding to neurons) or edges (corresponding to connections) of the graph are associated with weights, respectively.

The neurons may be arranged in layers, such that information may flow from a given neuron in one layer to one or more neurons in another layer of the neural network. In a CNN, a fully connected layer typically connects every neuron in one layer to every neuron in another layer. Fully connected layers may, therefore, be used to identify overall characteristics of an input, such as whether an object of a particular class, or a particular instance belonging to the particular class, is present in an input. For example, the input may comprise an image, video, or sound. A scheduled execution of a neural network, during which an input is provided to the “input layer” of the neural network and a corresponding output is provided from the “output layer” of the neural network, is referred to as a neural network ‘inference’. Each of the successive layers traversed during an NN inference may be calculated successively using the same hardware resources in an NPU.

In general, before they are implemented in an ‘operating phase’, neural networks may undergo what is referred to as a ‘training phase’, in which the neural network is trained for a particular purpose. The weights associated with one or more respective neurons in a neural network may be adjusted throughout training, which can alter the output of individual neurons and hence of the neural network

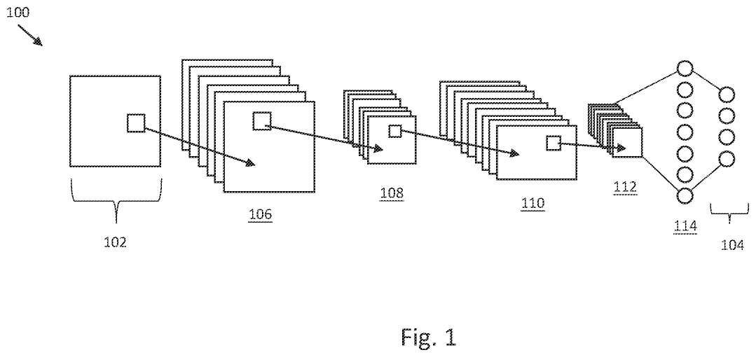

FIG. 1 shows a simplified representation of a convolutional neural network 100 which may be executed in a data processing system. Most convolutional neural networks comprise, in practice, more layers, and more channels or feature maps, than those shown in FIG. 1. A convolutional neural network 100 comprises a series of steps or layers, each of which apply one or more functions to the feature map(s) input to that layer. When executing a layer, a function is applied across the whole of an input feature map to produce an output feature map. An output feature map is either an intermediate feature map, which forms an input feature map for the next layer, or an output layer feature map which form an output of the neural network. For a convolution layer the function applied to an input feature map is in the form of a small filter matrix commonly known as the weights or kernel. Multiple kernels can be applied to each feature map to produce a plurality of output feature maps for use as input feature maps in the next layer. Other function types are also commonly used, for example Rectified Linear Unit (ReLU) and pooling.

The input data 102 in the example of FIG. 1 is an input feature map such as an image frame in which the data comprises pixel intensity and/or colour data. The output data 104 comprises one or more of a plurality of classification confidence data.

In this example, an inference is performed by executing the convolutional neural network in a data processing system. During an initial computational task of the data processing system, a first convolutional layer is executed, and multiple kernels are applied to the input feature map 102 to produce a plurality of output feature maps 106 for use as input feature maps for the next layer. During a subsequent computational task of the data processing system, a first pooling layer is executed, and pooling is applied to reduce the size of the intermediate feature maps and create pooled feature maps 108. During a further subsequent computational task of the data processing system, a second convolutional layer is executed, and multiple kernels are applied to the pooled feature maps 108 to produce a plurality of output feature maps 110 for use as input feature maps for the next layer. During a yet further subsequent computational task of the data processing system, a second pooling layer is executed, and pooling is applied to reduce the size of the intermediate feature maps and create pooled feature maps 112. During a yet further subsequent computational task of the data processing system, a fully connected layer is executed, to produce vectorised feature data 114. Not every convolutional neural network includes a fully connected layer; hence a corresponding computational task may be omitted in some convolutional neural networks. A final computational task of the data processing system, which completes the inference, is to execute an output layer to produce the output data 104.

If one or several elements in the input data 102 or output feature maps generated by the early layers (i.e. layers that are close to the input end, for example the first convolutional layer and/or the first pooling layer) of the convolutional neural network 100 are corrupted, the overall effect of that corruption on the output of the convolutional neural network 100 is usually generally not significant. For example, a CNN that that has been trained to detect images of cats will usually still reject images of dogs, without impactful deterioration of accuracy, even if several elements in the output feature maps generated by the early layers are corrupt. This is because, in part, the later layers in the CNN act upon the many values received from the early layers, creating an inherent resilience to minor imperfections (or corruption) in those early layers of the neural network or in the input data itself, for example an inaccurate or faulty pixel in a camera image.

The later layers in the convolutional neural network 100, which may for example include the second convolutional layer and/or the second pooling layer and/or a fully connected layer of the convolutional neural network 100, operate on feature maps that have been extracted from the input data 102 by the preceding (early) layers. As the input data is processed through the convolutional neural network 100, towards the later layers, the intermediate feature maps that are produced gain increased significance, as the layers progress towards the output of the network 100. Therefore, the impact of any inaccuracy tends to generally increase as the data is processed through the layers of a neural network, from its input end towards its output end.

As described above, a neural processing unit (NPU), or neural processor, may comprise a microprocessor or microchip or similar circuit that can operate on and efficiently process artificial neural networks. Neural processing units can be comprised within a wide range of different devices and systems, across a broad spectrum of technologies and applications. By way of non-limiting example, neural processing units can be found in devices and systems in the automotive, industrial, robotics and aerospace sectors, as well as in personal devices such as cameras, phones, handheld devices, gaming devices and many more.

A typical NPU comprises several types of component, including:

Central network control circuitry (NC)

Multiply accumulator engines (MEs)

Programmable compute elements (PEs)

The role, in general terms, of the network control circuitry (NC) is to manage execution of a neural network and to control the flow of data into and out of the neural processing unit. Some neural processing units may use a direct memory access (DMA) unit to control data flow, others may use a programmable processor, a central processing unit (CPU) or a combination of circuitry.

The multiply accumulator engines (MEs) in a neural processing unit are hardware-optimised for performing multiply-accumulate operations and for moving data into and out of the multiplier-accumulator units (MACs). Moving the data can be a challenging and differentiating aspect of a neural processing unit's operation. To address this, multiply accumulator engines may also contain storage, for example a memory for data buffering. MEs are usually responsible for the majority of the computations performed on the data comprised within certain types of neural network layers, for example convolutional layers. Typically, there is a plurality of MEs in a neural processing unit, and these are configurable to perform computations in parallel. A particular ME may be re-used to conduct different computations within a single layer and/or may be re-used used to conduct different computations in each of a plurality of different layers. The amount of re-use which is scheduled may be dependent on the hardware area available and/or power requirements, as well as a desired frequency of inferences.

The programmable compute elements (PEs) within a neural processing unit are flexible compute units that are capable of realising the layer types which don't fit well to the MEs, such as activation and pooling layers. PEs may also be arranged to exhibit local control capability. A PE can comprise, for example, a programable finite state machine or a central processing unit (CPU) that is arranged to execute a software program. Typically, there is a plurality of PEs in a neural processing unit, and these are configurable to perform computations in parallel. A particular PE may be re-used to conduct different computations within a single layer and/or may be re-used used to conduct different computations in each of a plurality of different layers. The amount of re-use which is scheduled may be dependent on the hardware area available and/or power requirements, as well as a desired frequency of inferences.

Some examples are described below, which relate to providing fault detection capabilities for neural processing units (NPUs) that can execute neural networks like the CNNs described above, and for devices and systems comprising one or more such neural processing units. Similar fault detection capabilities may also be provided for central processing units (CPUs) and graphic processing units (GPUs) which are designed to run at least part of a neural network. Such processing units may also include one or more NC, ME and/or PE, or similarly functional components. Whilst such different types of microprocessor will be referred to collectively below as “processing units”, it should be understood that the techniques described can be employed in NPUs, GPUs, CPUs and other types of microprocessor, individually or in a coprocessor arrangement.

As will become apparent from the detailed description that follows, it has been recognised herein that the fault detection capabilities of a processing unit can be tailored in accordance with, for example, the safety standards to be met, and/or with other requirements or expectations. For example, the fault detection capabilities of a processing unit can be tailored in order to meet a safety metric such as a PMHF target. It has also been recognised herein that the fault detection capabilities of a processing unit can be designed, selected, amended and/or tailored by considering one or more different parts or aspects of the processing unit separately to one or more other respective parts or aspects. Moreover, it has been recognised herein that the fault detection capabilities of a processing unit can be designed, selected, amended and/or tailored by considering, inter alia, the nature and particular details of a neural network that the processing unit is intended or expected to process.

As mentioned above, different components of a processing unit are operable to execute different respective layers of a neural network. Moreover, different layers within a neural network tend to have different respective responses, or tolerances, to the presences of faults either within the layer itself or within the input data to that layer. As a general rule, later (or subsequent) layers in a neural network, nearer its output, tend to have reduced immunity to failures, as compared to the earlier layers in the neural network, nearer the input. This is because, in part, the data is sparser in the earlier layers, spread thinly across many elements, and thus the effects of any single particular fault or inaccuracy on any given elements in the earlier layers is relatively small. Conversely, there is more data attributed per element within the later layers, so any given element in the later layers may experience a relatively large effect from a fault or inaccuracy within that data. Moreover, the later layers in a neural network act upon the many values received from the early layers, thereby creating an inherent immunity to minor imperfections in the early layers of the network or in the input data itself.

It has been recognised herein that the properties and/or behaviour of neural networks—including this variation in immunity to failures (or the variation in ability to produce accurate outputs in spite of the presence errors or faults) which is exhibited by different respective layers within a neural network—can be harnessed in order to guide the resilience properties (or levels) of a corresponding processing unit, which is expected or intended to run a particular neural network. For example, the properties and/or behaviour of the neural network can be used to guide the design, selection, amendment or tailoring of the fault detection capabilities of one or more layers of a neural network to be executed by the processing unit. As a result, a suitable level of resilience can be provided within the processing unit, in order for it (or a system in which it is comprised) to meet a target or requirement, such as an operational safety metric. For example, the processing unit can be provided with suitable resilience properties (or levels) in order to meet a target PMHF. Moreover, in many cases, this can be done in a more hardware-efficient and computationally efficient manner than has been achievable according to previously known methods.

The recognitions made herein enable the creation, selection, and/or amendment of a processing unit's hardware architecture that is tailored (at least in part) to the properties of one or more of the layers of a neural network that the processing unit is intended to run, or that the processing unit may be expected to run, in operation. At least in some cases, therefore, previously employed static measures for providing fault detection capability, for example the duplication of all hardware, can be avoided or at least reduced.

It is known that running a neural network generally involves significant amounts of computation. A tailored processing unit architecture that avoids, or decreases the extent of, hardware duplication can therefore reduce the number of computations that the processing unit has to make, whilst still providing functional safety. This can be useful, particularly in applications in which demand for neural processing is high.

Consideration of how to provide adequate fault detection capabilities within a data processing system, as described herein, can be done either when the data processing system is being designed, and/or as part of the manufacturing process, and/or when it is being programmed for running a particular neural network.

During design of the data processing system, consideration can be given to its possible or anticipated uses, and a suitable level of resilience can be determined or estimated for a processing unit, in order to meet expected target metrics (for example, likely PMHF targets) for such possible or anticipated uses. Thereafter, consideration can then be given to fault detection within the components of the data processing system, in order to provide a desired level of resilience, and a hardware configuration for the processing unit is then selected and arranged accordingly. When the data processing system subsequently undergoes programming, for running a particular neural network, a refinement can then be made, if appropriate, to tailor—for example, to scale back—the fault detection capability that has previously been provided in the hardware.

As will become apparent from the detailed examples below, it has been recognised herein that the fault detection capabilities of a data processing system can be considered as a whole and/or at a more granular level—for example, considering each of the neural network processing components of a processing unit such as the central network control circuitry (NC), multiply accumulator engines (MEs), and programmable compute elements (PEs) in turn. By considering different respective parts of the processing unit separately—including factors such as, for example: their respective functions; their respective proportional contributions to the overall hardware content and/or to the overall computational responsibility of the processing unit as a whole; the nature or identity of neural network layers upon which they will (or may) respectively act; and the importance of their correct operation to the overall safety of the processing unit and to any device or system in which it is incorporated—a tailored approach to fault detection can be achieved. Such a tailored approach can ensure that any functional safety standards are met whilst, at least in some cases, reducing the hardware requirements and/or the computational burden on the processing unit.

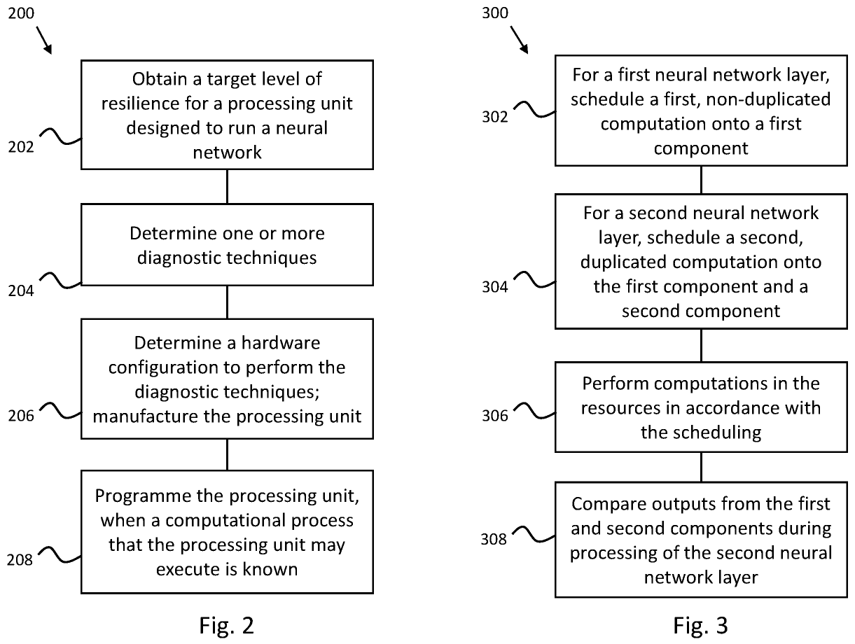

FIG. 2 comprises a summary of a method 200 that can be used for designing, selecting, amending and/or tailoring the fault detection (or ‘diagnostic’) capabilities of a processing unit, such as a central processing unit, a graphics processing unit, and a neural processing unit, in accordance with the recognitions made herein. The method 200 generates a hardware configuration addressing an operational performance target for a data processing system that is programmable to execute a first neural network layer and a second neural network layer. The operational performance target indicates a target performance characteristic of the data processing system when performing operations according to a neural network. The operational performance target in this example is a target level of resilience. The method 200 comprises:

At step 202, obtaining a target level of resilience for a processing unit designed to run at least part of a neural network. For example, the target level of resilience may be a level that is necessary in order for the processing unit, or for a system in which it is comprised, to meet one or more requirements or targets. The target level may be a maximum target level, with lower target levels being employed for faster performance using the same hardware. The processing unit may comprise, for example, a microchip, microprocessor or a similar circuit. For example, the step 202 of obtaining a target level of resilience may comprise making a determination or estimation of the target level of resilience. For example, the determination/estimation may be guided by one or more anticipated uses of the processing unit. For example, the determination/estimation may be guided by one or more reference examples. For example, a model may be used as part of the determination/estimation. For example, the requirement or target may be a target safety metric, for example a target PMHF. For example, the determination/estimation may comprise considering the resilience of one or more components of the processing unit, such as the central network control circuitry (NC), multiply accumulator engines (MEs) and programmable compute elements (PEs), individually. For example, the determination/estimation may consider one or more properties of a neural network that the processing unit will, or may, execute in practice.

At step 204, determining one or more diagnostic (i.e. fault detection) operation(s) for the processing unit are determined. This determination can be made, with the target level of resilience in mind. For example, the determination may comprise considering one or more neural processing components of a processing unit, such as the central network control circuitry (NC), multiply accumulator engines (MEs) and programmable compute elements (PEs), individually. For example, the determination may indicate that different respective diagnostic techniques (or fault detection operations) should be applied to different respective components of the processing unit when executing first and second layers of a neural network that the processing unit will, or may, execute in practice. For example, the determination may consider one or more properties of the first and second layers of the neural network that the processing unit will, or may, execute in practice.

At step 206, determining (or identifying) a hardware configuration that can be used to perform one or more of the determined fault detection operation(s). For example, this may comprise determining a hardware capability and/or a hardware architecture. The hardware requirements for different respective parts of the processing unit may be considered separately to one another. For example, it may be determined whether some or all of the hardware in the processing unit should be duplicated. For example, it may be determined whether different respective parts of the processing unit should be configured to perform one or more of the same (i.e. in common) operations. For example, it may be considered whether components that have flexible functionality should be used. The processing unit can now be manufactured, incorporating the hardware that it has been identified. Some additional hardware may also be incorporated, to perform other functions and/or to provide some redundancy and/or to accommodate possible future changes.

At step 208, which is an optional step that can happen after manufacture of the processing unit, programming or reprogramming of the processing unit to provide suitable resilience, using the available hardware resources, once a neural network that the processing unit may execute is known and trained. Programming or reprogramming of a neural network may instead or also be done after the processing unit has begun to execute the neural network. For example, if a fault is detected in one or more architectural components of the processing unit, during operation, reprogramming may occur to divert some functionality to one or more different respective architectural components.

It will be appreciated that the above steps merely provide a high-level summary, and that the precise details of the approach taken may vary on a case-by-case basis, as will become clear from the detailed examples set out below. Moreover, the steps of the method 200 set out above may not all be carried out for every processing unit. Furthermore, the steps of the method 200 set out above may not all be carried out by the same person or entity and may not happen concurrently or immediately sequentially to one another. For example, design of a processing unit may happen separately to hardware manufacture, which may also happen separately to programming.

Looking more closely at the step 202 of obtaining—for example, determining or estimating—a target level of resilience for a processing unit, it has been recognised herein that the expectations or requirements for such resilience may vary. For example, a target level of resilience may depend on the intended use and operation of a processing unit, and/or of the device or system in which it is incorporated. Possible methods for determining or estimating how much resilience may be required for a particular processing unit—for example, in order to meet the requisite safety standards for its intended use—is set out below.

One possible approach for determining or estimating resilience levels for a processing unit is to first make an educated assumption of appropriate resilience levels—which most designers or programmers of a processing unit should be well placed to do—and then perform a fault simulation offline, which simulates injection of faults into the hardware architecture of the processing unit. One can measure the resulting fault metrics from the simulation and determine the PMHF of each neural network layer, and of the overall neural network, during its simulated execution. Following the simulation, the diagnostic capability engaged by the NC during NN inferences can be adjusted. However, fault injection simulation of this type tends to be very computationally intensive and so can be impractical for very large software systems, including larger neural networks. This approach also typically entails access to detailed models of the processing unit hardware.

An alternative approach for determining or estimating resilience levels for a processing unit is to employ a ‘resilience tool’ that utilises a precomputed Architectural Vulnerability Model (AVM) of the processing unit hardware. Using the AVM, it possible to simulate a processing unit and run it with an intended neural network or other software. This avoids the need for a detailed model of the processing unit, or the very high level of computations that would be needed for determining or estimating a resilience level based on fault injection simulation.

The resilience tool works by executing a neural network on the AVM for the processing unit, with both low and high resilience configurations. The neural network executed on the AVM can be a specific one that the processing unit is intended to run, or an example neural network of the type that the processing unit might be expected to run, in operation. The fault metrics, such as the PMHF, output as a result of running the neural network on the AVM can then be reviewed. Any layers of the neural network that the review indicates provide the most significant contribution to PMHF are then selected for high resilience computation—that is, the computation is re-run with the component(s) of the processing unit that execute those layers being simulated as having high resilience. The selection of which layers should be executed by high resilience hardware can be done in stages, for example layer-by-layer or in groups of layers, until the PMHF of the overall neural network falls within the target for the processing unit.

The NC of a processing unit can be programmed, as a result of AVM simulation, to automatically reconfigure the processing unit for execution of each respective neural network layer, the execution of which has been simulated. This enables the processing unit to be used, in operation, to execute many different neural networks with an acceptable level of resilience, and with a relatively low amount of computation.

By using an AVM, a resilience tool is created that is suitable for use both by those who programme processing units, and those who design microprocessors. The resilience tool can automatically select the most appropriate resilience configuration for a processing unit, based on the layers of the respective neural network.

Other methods of determining or estimating resilience levels may also be used. For example, resilience levels for a processing unit may be estimated based on reference examples of other, similar processing units. In some instances, it may not be appropriate or possible to consider resilience for different hardware component types of the processing unit separately.

The above notwithstanding, it has been recognised herein that there are some patterns as regards the typical resilience expectations or requirements of the different respective hardware component types of a processing unit. Looking at those parts, in turn:

The central network control (NC) circuitry is generally independent of the neural network layers that are to be operated on, and it is usually responsible for managing, or orchestrating, the execution of a neural network by the neural processing unit as a whole. Largely correct (substantially fault-free) operation of the central network control circuitry is therefore generally expected for successful operation of a processing unit;

By contrast, the significance of faults in multiply accumulator engines (MEs) can vary, depending on the respective neural network layer(s) computed. As a general rule, transient faults can have a limited impact on successive multiply accumulator engine computations;

The significance of faults in programmable compute elements (PEs) can also vary, depending on the respective neural network layer(s) computed. The impact of a fault in a PE can be higher than that of a similar fault in an ME, because PEs contain local control capability, which can cease to function correctly following a transient fault. However, in practice, certain types of PEs, for example programable circuits such as CPUs, typically have a low utilisation of their circuitry, such that many transient faults have no significant impact to correct operation of those PE types.

The hardware components considered for use in a design may affect which fault detection operation or operations are determined for such use, and the method 200 may comprises considering at least one of:
the susceptibility of and impact of error of a first component;
a size of a first component;
a number of processing elements within a first component;
an intended or potential function of a first component; and
a potential contribution of a first component, to meeting the operational performance target for the data processing system.

FIG. 3 shows a summary of a method 300 that can be used for scheduling computations onto a plurality of data processing resources of a data processing system, comprising one or more processing units such as a central processing unit, a graphics processing unit and/or a neural processing unit, in accordance with the recognitions made herein. The method 300 comprises:

At step 302, for a first neural network layer, scheduling a first computation onto a first of the plurality of parallel computing components, such that the first computation is scheduled as a non-duplicated computation in which the first component performs a computation which is not scheduled to be performed by any other of the plurality of parallel computing components.

At step 304, for second neural network layer, scheduling a second computation onto the first component and onto a second, different, one of the plurality of parallel computing components, such that the second computation is scheduled as a duplicated computation,

At step 306, performing computations in each of the plurality of parallel computing components in accordance with the scheduling.

At step 308, comparing outputs from the first and second components in order to selectively provide a component-level fault detection operation in relation to the first component during the second neural network layer. If the outputs are the same, no fault is detected, and if the outputs differ, a fault is detected. No component-level fault detection operation is provided in relation to the first component during the first neural network layer.

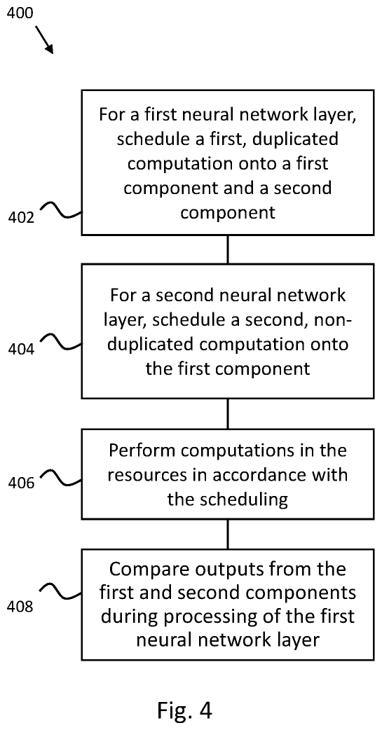

FIG. 4 shows a summary of an alternative method 400 that can be used for scheduling computations onto a plurality of data processing resources of a data processing system, comprising one or more processing units such as a central processing unit, a graphics processing unit and/or a neural processing unit, in accordance with the recognitions made herein. The method 400 comprises:

At step 402, for first neural network layer, scheduling a first computation onto a first of the plurality of parallel computing components, and onto a second, different, one of the plurality of parallel computing components, such that the first computation is scheduled as a duplicated computation,

At step 404, for second neural network layer, scheduling a second computation onto the first component, such that the second computation is scheduled as a non-duplicated computation in which the first component performs a computation which is not scheduled to be performed by any other of the plurality of parallel computing components.

At step 406, performing computations in each of the plurality of parallel computing components in accordance with the scheduling.

At step 408, comparing outputs from the first and second components in order to selectively provide a component-level fault detection operation in relation to the first component during the first neural network layer. If the outputs are the same, no fault is detected, and if the outputs differ, a fault is detected. No component-level fault detection operation is provided in relation to the first component during the second neural network layer.

In relation to each of the above methods of FIGS. 3 and 4, in an alternative to duplicating a particular computation onto a second component, the two data processing resources onto which the duplicated computation is scheduled may instead be two consecutive data processing intervals of usage of data processing resources on the first component, with a first instance of the duplicated computation and a second instance of the duplicated computation being scheduled in sequence, and with the output from the first instance of the duplicated computation being buffered and compared with the output from the second instance of the duplicated computation to provide the component-level fault detection operation in relation to the first component. In each of the above methods of FIGS. 3 and 4, when a fault is detected, the microprocessor or the component in which the fault is detected may automatically re-execute the neural network layer for which the error is detected and potentially flag an issue; another option is for the microprocessor or component performing the comparison to just flag the issue, for subsequent remedial action to be taken by the microprocessor or by the host device.

In each of the above methods of FIGS. 3 and 4, the method may include, for the neural network layer for which a non-duplicated computation is scheduled onto the first component, scheduling a third computation, different to the non-duplicated computation, onto the second component, which improves data processing speed and enables reduced inference latency. Alternatively, the second component to be placed in a low-power state in which no computation is performed, which enables lower power operation.

In exemplary methods corresponding with the methods of FIGS. 3 and 4, the first and second neural network layers may comprise respective earlier and later layers of a neural network, such as a convolutional neural network as described above, in a processing unit. In accordance with the method of FIG. 3, the described duplicated computation, along with other similarly duplicated operations, may be scheduled to be performed in a layer which is later than a layer in which the described non-duplicated computation, along with other similarly non-duplicated operations, is or are scheduled to be performed. In accordance with the method of FIG. 4, the described duplicated computation, along with other similarly duplicated operations, may be scheduled to be performed in a layer which is earlier than a layer in which the described non-duplicated computation, along with other similarly non-duplicated operations, is or are scheduled to be performed.

The scheduling of duplicated operations may be performed in accordance with one or more properties of the one or more layers of the neural network. Once a property is determined, the determined property may be used to determine whether fault detection should be enabled, or a suitable fault detection operation that should be used, for a neural network layer, in order to address an operational performance target for the neural network. Such a property may correspond to a layer's sensitivity to errors, and may for example be:

Layer type, e.g. a pooling layer could be more sensitive to single bit errors;

Layer size, e.g. the larger the layer dataset the longer the computation period, which may cause an increased probability of error;

Location of layer in the network (latter layers are likely to be more sensitive to errors).

In further exemplary methods corresponding with the methods of FIGS. 3 and 4, the first and second neural network layers may comprise the same layer, or different, layers in respective inferences of a neural network, such as a convolutional neural network as described above, in a processing unit. For example, one or more layers in 1 of N inferences may be run with high redundancy in order to exercise more of the NPU, with redundancy used as a way of detecting faults. This diagnostic processing may be scheduled by the NC.

It is also possible to have a neural network layer where a subset of components, say 6 out of 8 components are nonredundant and another subset, say 2 out of 8, duplicate each other. The configuration could be varied between inferences or layers within an inference so that the redundant components are alternated or rotated. For example, components A and B may be duplicated, with components C and D, which are configured to conduct computations in parallel with A and B, being nonredundant for inference or layer 1 and then C and D may be duplicated, with components A and B being nonredundant, for inference or layer 2. This diagnostic processing may be scheduled by the NC.

In a further variation, which may be used in addition or in the alternative, components are kept out of a neural network layer so they can be tested while the others perform computation, again alternating or rotating between inferences (testing may require more time than one layer provides). Again, this diagnostic processing may be scheduled by the NC.

Some particular examples will now be considered.

By way of a first example, a system is considered that is classified as being ‘safety-critical’ and which therefore requires an overall high level of resilience. For example, the system may have an ISO 26262 ASIL D or IEC 61508 SIL 3 safety integrity. In such a system, very low PMHF and very high SPFM targets are generally expected.

Looking first at the central network control circuitry (NC), in this example it is determined that reliable operation of the network control circuitry is critical, because it is responsible for orchestrating the execution of the corresponding neural network for the safety-critical system. Therefore, a high level of resilience of the NC is preferred.

Because a high level of resilience of the NC is preferred in this example, it is determined that the most appropriate diagnostic (i.e. fault detection) technique is to provide full hardware duplication for the NC. Such duplication provides for continuous checking of the NC and can detect both permanent and transient faults. In operation, if a fault is detected in the NC, the processing unit can be reset, and detailed diagnostics can be run to determine whether the detected fault is permanent. Storage can be protected by use of one or more error correction and/or detection codes (ECCs). The storage can be subjected to memory built-in-self-test (MBIST), under control of the NC.

Continuing with the first example, of a safety-critical system, and now considering the programmable compute elements (PEs), because the overall system may have a relatively high resilience target, for a particular design of processing unit, it may be determined that the best option for fault detection for the PEs is full hardware duplication. Such duplication in a simple design may be relatively costly, but not usually prohibitively so, because the PEs are likely to make up a relatively small proportion of the design and of the associated cost of the processing unit. Storage can be protected by one or more ECCs. The storage can be subjected to MBIST, under control of the NC or of the PEs.

Still considering the PEs in this first example, it has been recognised herein that, instead of defaulting to hardware duplication for the PEs, a more tailored approach may be adopted. This can be particularly worthwhile for more complex designs of processing unit, for which complete PE hardware duplication is likely to be costly and burdensome in terms of computation and power consumption.

For example, the nature of the neural network layers that a PE is (or potentially will be) intended to execute can be considered, in order to determine an acceptable level of resilience for the PE and to determine an appropriate diagnostic approach and corresponding hardware solution for that PE. For example, the immunity of the layer(s) of the neural network to transient faults, and/or the requirements for accuracy of output from the layer(s) can be considered, in order to determine how much resilience should be provided in the corresponding PE(s), and therefore how best to provide diagnostic (i.e. fault detection) capability within those PEs. For example, the resilience levels that are appropriate for each layer (or for certain of the layers) of a neural network may be determined or estimated using an AVM, as detailed above, or by another appropriate modelling or estimation approach. Fault detection capabilities for the PEs can then be provided accordingly.

As part of this tailored approach, one option is for the NC to arrange certain PE computations to occur only once during one or more computational tasks scheduled for the execution for selected layers, and for certain PE computations to occur twice, in independent PEs, during one or more computational tasks scheduled for the execution for selected layers. When a layer is configured for high resilience, computation for that layer can be scheduled on two PEs, with results checked by the NC. Corruption due to a fault can be detected by the comparison (by the NC) of the results from the two independent PEs. Such a comparison can include fault detecting control code, for which the most common failure mode is non-response, which the NC can detect using a timeout. Fault detection can be further improved by additional periodic checking using a software test library (STL) or logic built-in-self-test (LBIST), which detects faults in more of the circuitry than a constrained execution does.

The PE configuration of the processing unit according to this first example may also (or instead) be refined by the use of hardware components specifically designed for fault detection. For example, a ‘split-lock’ PE design can be implemented, to allow for tailoring of the diagnostics for each layer of a neural network that the processing unit will run. A split-lock PE hardware design provides flexibility between a ‘split’ mode, in which two (or more) PEs operate separately from one another, and a ‘lock’ mode in which the operations of the two (or more) PEs are duplicated. Such a design provides selective PE-level fault detection, which is configurable by the NC when the corresponding PE(s) is/are quiescent. It can therefore avoid complete hardware duplication for the PEs, without compromising on safety. When, at the time of programming, the neural network that is to be run by the processing unit is known and has been trained, any layers that are to be configured for reduced resilience can be identified and thus a determination can be made not to duplicate operation of the PE hardware for scheduled computational tasks corresponding to those layers. Those PEs can therefore be selectively operated in ‘lock’ mode and ‘split’ mode, depending on the layer being executed, with different modes being employed in different neural network layers during a single inference. An alternative diagnostic technique can instead be implemented for those layers. For example, a periodic test operation such as a software test library (STL) or logic built-in-self-test (LBIST) can be used.

Continuing with this first example, it has been recognised herein that applying a tailored approach to the multiply accumulator engines (MEs) within a processing unit can provide a significant opportunity for cost savings and hardware reduction, as compared to previous systems in which the default was to automatically duplicate all hardware, for diagnostic purposes.

Similar to what is described above in relation to the PEs, the NC can arrange for selective ME-level fault detection by scheduling the computation(s) for selected neural network layers that configured for relatively high resilience to occur on multiple independent MEs, with checking of the respective outputs of those MEs being performed by the NC, and by scheduling the computation(s) for other neural network layers that are configured for lower resilience to occur on single MEs. However, in certain configurations of processing unit, a relatively high number of MEs means that the overhead of the NC comparing results output by relatively large numbers of sets of two independent MEs, is likely to be costly and computationally intensive and so may not be an attractive option.

An alternative, for at least some of the MEs in a processing unit, is to have pairs of split-lock MEs, which are configurable by the NC, when quiescent, to be either duplicated (i.e. in ‘lock’ mode) or separated (i.e. in ‘split’ mode). The configuration of split-lock MEs be determined occur during the programming stage, once the neural network that the processing unit is going to run is known and has been trained. A determination can be made at that stage—or at an earlier stage, for example when determining the potential suitability of a processing unit for executing a particular neural network, and/or when designing a processing unit and considering its potential uses—regarding which MEs are configured using hardware duplication and which do not. Such a determination may be guided by the resilience to be configured for the corresponding layers of the neural network. Once determined, the configuration of split-lock MEs, which will be scheduled during different computational tasks corresponding to different layers of the neural network may be programmed into a control program to be run in the NC, in a device driver for the NPU and/or in a host device. The computational tasks may be tagged to indicate which of the computations should be replicated.

In operation, when an ME is duplicated, the diagnostic checking (i.e. fault detection) can be performed by hardware comparison, comparing the respective outputs of the two duplicated MEs, which is generally efficient and does not burden the NC. On the other hand, when two MEs within a pair are split, or separated, and therefore do not have hardware duplication for fault detection, fault detection for each ME can instead be performed via a periodic test operation such as a STL run by the NC or by the PEs, or an LBIST under control of the NC. The storage/memory can be subjected to MBIST, under control of the NC.

Therefore, as demonstrated above in relation to this first example, the configuration and/or operation of one or more of a processing unit's components—and the level and nature of fault detection provided for those parts—can be intelligently duplicated. This can enable efficient use of the processing unit and can avoid unnecessary hardware duplication. It can enable power to be saved because, if one or more neural network layers is identified as having high immunity to transient faults—or for some other reason is identified as not requiring high resilience and therefore not necessarily requiring duplication for diagnostic purposes. Any corresponding hardware within the processing unit that is consequently not used for computation can be placed in a low-power state (e.g. disabled or powered down) in which no computation is performed. Alternatively, the corresponding hardware may be used for additional computations, thereby the improve performance and reduce the inference latency. Moreover, reducing duplication reduces the amount of data checking and duplicated computation that a processing unit must perform, which in turn reduces the power consumed by the processing unit. It also improves the operational efficiency and the commercial viability of the overall system, in which the processing unit is comprised.

By way of a second example, a ‘safety nominal’ system is considered, such as those designed for ISO 26262 ASIL B and IEC 61508 SIL 2 safety integrities. Typically, the SPFM and PMHF metrics are less demanding for safety nominal systems, as compared to safety critical systems. Therefore, a lower overall level of resilience of system is expected or required, as compared to safety critical systems. As a result, it has been recognised herein that a different compromise between diagnostic capability and cost or burden can be considered and may be achievable.

In a safety nominal system, it may be determined that, because of the lower resilience expectations or requirements on the system, it is sufficient for the NC logic to be checked periodically, such as with an STL, typically between NN inferences. However, since there is typically significant dependence on the NC for orchestration and interaction with the rest of the processing unit, in this example it is determined that the NC hardware is nonetheless duplicated, with shared storage between duplicated NC components. This should ensure that the NC logic is available with sufficient resilience.

Looking at the other components of the processing unit in this second example, it is determined that, in order to provide appropriate resilience in order to meet the safety metrics such as PMHF for the safety nominal system, it is sufficient for the PEs and MEs to be tested by a periodic operation, such as a software test library (STL) or logic built-in-self-test (LBIST). Such testing can be scheduled to occur within a so-called ‘fault detection time interval’, which may be set to be greater than one NN inference, meaning there is no testing between NN layers using the periodic operation. Even without varying the level of testing for different component PEs and/or MEs, based on the vulnerability of each layer that they respectively run, the properties of the layers can still be exploited by taking into account a lower PMHF contribution from less significant layers relative to that of the more significant layers, such that the more time spent computing less significant layers, the lower the PMHF over the duration of the NN inference.

Thus, it can be seen from the first and second examples above that tailored, intelligent approaches can be taken to providing diagnostic (i.e. fault detection) capabilities within a processing unit, which can enable a single type or design of processing unit to have a greater number and breadth of possible applications. For example, by providing split-lock PEs and/or split-lock MEs within a processing unit, that same unit can be configured for use in either safety-critical systems (in which at least some of the PEs and MEs would operate in lock mode) or safety-nominal systems (in which more of the PEs and MEs are likely to operate in split mode). The mode in which each PE and/or ME is to operate (i.e. whether it should operate separately in ‘split’ mode or in conjunction with a duplicate in ‘lock’ mode) can be selected by programmable control of the processing unit.

Any hardware that is not active during a computational task—for example, as a result of duplication of operations being reduced or eliminated—can be disabled or powered down. Alternatively, or additionally, any PEs and/or MEs within a processing unit that are enabled to work in ‘split’ mode, as opposed to ‘lock’ mode, can become available for performing additional computations, or realising additional or other neural network layers. As a result, a given type, design or configuration of processing unit that previously may have been deemed unsuitable for, or incapable of, running certain types of neural network may now be deemed capable of and suitable for running such a neural network, due to the additional computational power that is effectively freed up, as a result of reducing duplication of operations.

According to a third example, an intermittent or periodic approach to duplication of computations within a processing unit is adopted. In this third example, the central network control circuitry (NC) controls a duty cycle of duplication and non-duplication of computations. For example, in one computational task, an ME processes a stream of data inputs until a layer is completed. During that computational task, some of the data inputs are copied to so-called ‘redundant’ hardware to enable duplicated computation. The redundant hardware in this example may comprise an additional MAC, buffer and related circuitry within an ME or it may comprise such elements in another, redundant, ME. By performing at least some, but not all, computations more than once, an appropriate degree of fault checking is performed.

It will be appreciated that whether such intermittent duplication is acceptable for a processing unit, and what frequency the duty cycle of any intermittent duplication should take, may vary on a case-by-case basis, depending on the resilience expectations or requirements that have been determined or estimated for the processing unit in a given context. For example, the resilience expectations or requirements may depend on the applicable safety metrics for the processing unit for running a given neural network, or on the applicable safety metrics for the processing unit being implemented as part of a particular system or for a particular intended purpose. In general, the NC of the processing unit may be used to control how many MEs or PEs, or the modular resources such as MACs within them, should be used for primary computation and which should be used for secondary computation. For example, a processing unit may be designed with additional hardware to ensure there are sufficient resources to perform checking and to meet its performance and/or safety standards.

According to a fourth example, a system is provided that comprises multiple processing units. For example, any of the approaches and solutions described in detail above can be implemented in a multiple neural processing unit (multi-NPU) system. Additionally, or alternatively, it is possible to configure certain processing units as slaves to other processing units, in order for their combined resources to be used to achieve redundancy and/or increased performance.

The system in this fourth example comprises two processing units, which can be configured, for example, in any of the following four ways:
1. The two processing units operate independently of one another.
2. The two processing unit resources are combined to enable redundancy (i.e. duplication) by computing some or all neural network layers more than once, under control of a single network controller.
3. The two processing unit resources are combined to achieve increased performance (i.e. more computations) under control of a single network controller.
4. A combination of configurations 2 and 3.

Where processing units are combined, their respective central network control circuitries (NCs) can be configured in a lockstep arrangement—i.e., they can be configured to run the same set of operations at the same time, in parallel to one another—in order to improve redundancy. This can be achieved through a lockstep NC within one of the processing units, or by coupling the NCs of the two processing units or through software techniques under control of the processing units' device drivers, running on a separate central processing unit (CPU).

In systems such as this, where multiple processing units are provided, redundancy can be provided, for diagnostic purposes, in a selective and/or tailored manner, whilst causing limited disruption to the design or configuration of any individual processing unit. Systems in which the resources are separated into several processing units also achieve improved isolation of the redundant parts of a computation, which can improve the system's overall functional safety.

The above approaches and solutions can be highly useful, for improving the efficiency and the flexibility of processing units, without compromising on safety or other standards that must be met. This can be useful in applications that entail a large amount of neural processing, which therefore demand high levels of computational efficiency. For example, functional safety systems in sectors such as the automotive sector, including autonomous vehicles, can entail large amounts of neural processing. However, the processing units described herein, and the approaches for designing, manufacturing, programming and tailoring them, can have application across many sectors and in a range of system types.

As well as being useful for providing intelligent, streamlined diagnostic capability for one or more processing units, as detailed above, the approaches and solutions described herein can be employed to avoid or ‘work around’ permanent faults that occur in the MEs and/or the PEs of a processing unit. This can be done by dynamically adjusting the orchestration of the execution of a neural network by the processing unit, to avoid faulty hardware. Such an adjustment can be controlled by the processing unit's central network control circuitry (NC).

Adjusting the orchestration of the execution of a neural network by a processing unit, when faults are detected during a NN inference, can also be used to perform a ‘replay’ whilst the hardware awaits detailed diagnostics. This enables the diagnostics to be run in parallel to computation using the PEs and MEs that are known to be functional.

It is also possible to reinstate hardware that has been diagnosed as functional, following a transient fault, for use in subsequent layers.

The above described approaches improve the overall hardware availability of a processing unit, and its flexibility. This is valuable, for example in systems that have to meet high safety standards, such as in the automotive industry, for example autonomous vehicles.

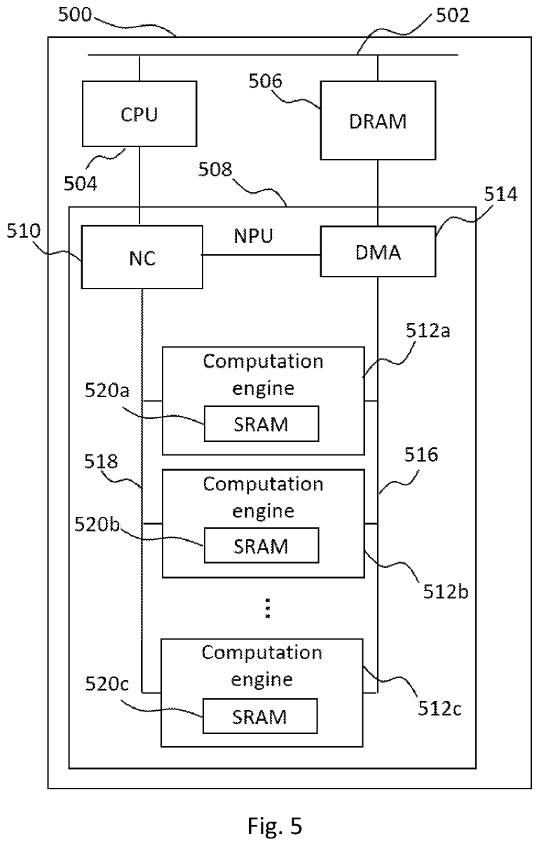

FIG. 5 shows an example of a data processing system 500 arranged in accordance with an embodiment of the present disclosure. The data processing system 500 incudes a system bus 502 connected to a central processing unit (CPU) 504 and dynamic random-access memory (DRAM) 506. The system bus 502 may also be connected to other components not shown in FIG. 5, for example non-volatile storage, input/output devices, a graphics processing unit (GPU), and one or more network interfaces. The data processing system 500 also includes a neural processing unit (NPU) 508, designed and configured as described in any of the above examples.

The NPU 508 includes central network control circuitry (NC) 510, which includes processing circuitry arranged to generate control data for multiple parallel computing computation engines, referred to collectively as computation engines 512.

Three of the computation engines, 512a-c, are shown in FIG. 5. In the present example, the NPU 508 includes sixteen computation engines 512, though it will be appreciated that different numbers of computation engines could be employed without departing from the scope of the invention. The computation engines 512 are arranged to receive input data from the DRAM 506 via a direct memory access (DMA) 514 and a main data channel 516. The input data received from the DRAM 506 can include, for example, image data, along with weight data associated with kernels to be applied within a given CNN layer. The computation engines 512 are arranged to process the received input data in accordance with control data received from the NC 510 via a control data channel 518.

Each of the computation engines 512 includes static random-access memory (SRAM) 520. The computation engines 126 include processing circuitry configured to retrieve input data stored by the SRAM 520 for processing.

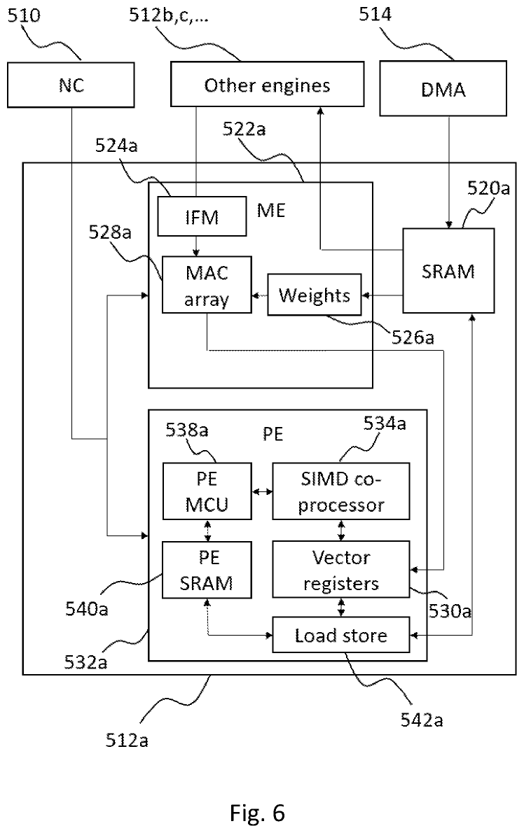

FIG. 6 shows a computation engine 512a in more detail. In the present example, the other computation engines 512b, c, . . . include substantially the same components as the computation engine 512a. In addition to the SRAM 520a mentioned above, the computation engine 512a includes a multiply accumulator engine (ME) 522a, which is arranged to process data retrieved from the SRAM 520 of the computation engines 520 in accordance with control data received from the NC 510. The ME 522a includes an input feature map (IFM) buffer 524a and a weights buffer 526a for passing IFM data (or image data) and weights data respectively to a MAC array 528a. The MAC array 528a includes multiple MAC units and accumulators for performing MAC operations in parallel to execute a neural network layer.

The ME 522a may be arranged to transmit output feature data to a vector register array 530a of a programmable compute element (PE) 532a. The PE 532a includes a single-instruction multiple data (SIMD) co-processor 534a arranged to perform vector operations on data stored in the vector register array 530a.

The PE 532a is arranged to perform, for example, pooling operations and to apply activation functions. The PE 532a can be programmed to perform different operations for different layers within a given CNN, allowing for a broad range of CNN architectures to be implemented. Accordingly, the PE 532a includes a PE microcontroller unit (MCU) 538a, which is arranged to execute program data stored by PE SRAM 540a. The PE 532a further includes a load store 542a, which is arranged to transfer data in an efficient manner between the SRAM 130a, the vector registers 150a, and the PE SRAM 148a.

The PE 532a is arranged to output the processed output feature map data, via the load store 542a, to the SRAM 512a of the computation engine 512a. In the context of a CNN, the processed output feature map data becomes input feature map data for the next layer in the CNN, which may be, for example, a further convolutional layer or a fully connected layer. The processed data may be broadcast to the other computation engines 512 for further processing, or may be output to the DRAM 506 of the data processing system 500.

The above examples are to be understood as illustrative only. Further possible arrangements and approaches are envisaged. For example, whilst in the above examples fault detection is conducted during the performance of individual inferences of a neural network, fault detection may similarly be conducted during the performance of individual training runs of a neural network, with duplication being selectively activated during different layers of the neural network during one training run. Further, whilst in the above examples the specialised parallel computing processing unit is an NPU, similar arrangements of fault detection configurations and operations may be used in other kinds of specialised parallel computing processing unit, for example vision processing units (VPUs), which are specialised for machine vision algorithms such as a scale-invariant feature transform (SIFT) algorithm, or other types of artificial intelligence (AI) hardware accelerator.

In the above, reference is made to “duplication” of a computation. This term should not be understood to mean that a computation is necessarily replicated only twice (when in practice could be three or more times).

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1. A method of performing fault detection during computations relating to a neural network comprising a first neural network layer and a second neural network layer in a data processing system, the method comprising:
scheduling computations onto data processing resources for the execution of the first neural network layer and the second neural network layer, wherein the scheduling includes:
for a given one of the first neural network layer and the second neural network layer, scheduling a respective given one of a first computation and a second computation as a non-duplicated computation, in which the given computation is at least initially scheduled to be performed only once during the execution of the given neural network layer; and,
for the other of the first and second neural network layers, scheduling the respective other of the first and second computations as a duplicated computation, in which the other computation is at least initially scheduled to be performed at least twice during the execution of the other neural network layer to provide a plurality of outputs;
performing computations in the data processing resources in accordance with the scheduling; and,
comparing the outputs from the duplicated computation to selectively provide a fault detection operation during processing of the other neural network layer.

2. The method according to claim 1, comprising:
for the given neural network layer, scheduling the given computation onto a first of a plurality of computing components, such that the given computation is scheduled as a non-duplicated computation in which the first component performs a computation which is not scheduled to be performed by any other of the plurality of computing components; and,
for the other neural network layer, scheduling the other computation onto the first component and onto a second, different, one of the plurality of computing components, each of the first and second components providing a respective one of said plurality of outputs.

3. The method of claim 2, wherein the scheduling includes, for the given neural network layer, scheduling a third computation, different to the given, non-duplicated, computation, onto the second component.

4. The method of claim 2, wherein the scheduling includes, for the given neural network layer, scheduling the second component to be placed in a low-power state in which no computation is performed.

5. The method of claim 2, wherein the first and second components comprise multiply accumulator engines under the control of central network control circuitry.

6. The method of claim 2, wherein the first and second components comprise programmable compute engines under the control of central network control circuitry.

7. The method of claim 5, wherein at least part of the central network control circuitry is duplicated in hardware to increase the resilience of the central network control circuitry.

8. The method of claim 1, wherein the first neural network layer and the second neural network layer are executed during the performance of one inference or one training run of a neural network, each layer being a different layer of the neural network.

9. A data processing system configured to perform fault detection during computations, the data processing system comprising:
control circuitry; and,
one or more computing components configured to provide data processing resources,
wherein the control circuitry is configured to schedule computations onto the plurality of data processing resources for the execution of a first neural network layer and a second neural network layer, including:
for a given one of the first neural network layer and the second neural network layer, scheduling a respective given one of a first computation and a second computation as a non-duplicated computation, in which the given computation is at least initially scheduled to be performed only once during the execution of the given neural network layer; and,
for the other of the first and second neural network layers, scheduling the respective other of the first and second computations as a duplicated computation, in which the other computation is at least initially scheduled to be performed at least twice during the execution of the other neural network layer to provide a plurality of outputs,
wherein the data processing system is configured to compare the outputs from the duplicated computation to selectively provide a fault detection operation during processing of the other neural network layer.

10. A method of generating a hardware configuration addressing an operational performance target for a data processing system that is programmable to execute a first neural network layer and a second neural network layer, the method comprising:
determining a first operation for one of the first neural network layer and second neural network layer;
determining a first fault detection operation for the other of the first neural network layer and the second neural network layer, wherein the first operation and the first fault detection operations may differ from one another and wherein a combination of the first operation and the first fault detection operation can address the operational performance target for the neural network; and,
determining a hardware configuration for the data processing system, wherein the hardware configuration is operable to provide the first operation and the first fault detection operation.

11. The method of claim 10, further comprising providing a data processing system that comprises the hardware configuration that is operable to provide the first operation and the first fault detection operation.

12. The method of claim 10, wherein the operational performance target relates to a resilience target for the neural network.

13. The method of claim 10, wherein the data processing system comprises a neural processing unit that is programmable to execute the neural network.

14. The method of claim 10, in which determining the first operation and/or the first fault detection operation comprises:
determining a property of at least the first neural network layer; and,
using the determined property to determine whether fault detection should be enabled, or a suitable fault detection operation that should be used, for the first neural network layer, in order to address the operational performance target for the neural network.

15. The method of claim 10, comprising:
determining a property of at least the first neural network layer; and,
configuring the first operation and/or the first fault detection operation in view of the determined property of one or more layers of the neural network, in order to address the operational performance target for the neural network.

16. The method of claim 10, wherein determining the first operation and/or the first fault detection operation comprises considering at least one of:
the susceptibility of and impact of error of a first component;
a size of a first component;
a number of processing elements within a first component;
an intended or potential function of a first component; and,
a potential contribution of a first component, to meeting the operational performance target for the data processing system.

17. The method of claim 10, wherein the step of determining a hardware configuration for the data processing system comprises determining whether to duplicate some or all of the hardware comprised within the first component.

18. The method of claim 10, wherein the step of determining the first fault detection operation for the first component comprises determining whether a computation that a first processing element within the first component is operable to make should also be carried out in a first processing element within a different component, which can be configured to make duplicated computations with the first component.

19. The method of claim 10, wherein the step of determining the first fault detection operation for the first component comprises determining whether operation of the first component can be monitored without duplicating all the hardware within the first component, in order to address the operational performance target for the data processing system.

20. A non-transitory computer-readable storage medium comprising computer-executable instructions stored thereon which, when executed by at least one processor, cause the at least one processor to generate a hardware configuration addressing an operational performance target for a data processing system that is programmable to execute a first neural network layer and a second neural network layer, the instructions comprising the steps of:
determining a first operation for one of the first neural network layer and second neural network layer;
determining a first fault detection operation for the other of the first neural network layer and the second neural network layer, wherein the first operation and the first fault detection operations may differ from one another and wherein a combination of the first operation and the first fault detection operation can address the operational performance target for the neural network; and,
determining a hardware configuration for the data processing system, wherein the hardware configuration is operable to provide the first operation and the first fault detection operation.
